(19) United States
(12) Patent Application Publication
(10) Pub. No.: US 2025/0244655 A1
(43) Pub. Date: Jul. 31, 2025

(54) PROJECTION SYSTEM AND PROJECTOR CART

(71) Applicant: SEIKO EPSON CORPORATION, Tokyo (JP)

(72) Inventor: Yoichi FUJIKAWA, Azumino-shi (JP)

(73) Assignee: SEIKO EPSON CORPORATION, Tokyo (JP)

(21) Appl. No.: 19/041,738

(22) Filed: Jan. 30, 2025

(30) Foreign Application Priority Data
Jan. 31, 2024 (JP) 2024-012629

(51) Int. Cl. G03B 21/54; G03B 21/14; G03B 21/20

(52) U.S. Cl. CPC G03B 21/54; G03B 21/145; G03B 21/206

(57) ABSTRACT

A projection system includes a projector, and a projector cart configured to house the projector, wherein the projector includes an enclosure, a light source housed in the enclosure, a light modulator housed in the enclosure and configured to modulate light emitted from the light source, and a projection lens unit configured to emit the light modulated by the light modulator to an outside of the enclosure, and in a posture of using the projector, the projector cart includes a housing which is configured to house the projector and is configured to emit the light emitted from the projection lens unit to an outside of the projector cart, a base placed below the housing, and wheels placed below the base, and the base includes a rotor on which the housing is rotatably mounted.

The present application is based on, and claims priority from JP Application Serial Number 2024-012629, filed Jan. 31, 2024, the disclosure of which is hereby incorporated by reference herein in its entirety.

### BACKGROUND

### 1. Technical Field

The present disclosure relates to a projection system and a projector cart.

### 2. Related Art

In the past, a projector that projects projection light onto a screen or the like to thereby display an image has been known. A rack for a projector which is capable of improving convenience even when moving the projector has been known (see, e.g., JP-A-2012-098644).

JP-A-2012-098644 is an example of the related art.

There is a problem that fine adjustment in a

horizontal direction is difficult since the wheel moves freely when installing a projector rack.

### SUMMARY

A projection system according to the present disclosure includes a projector, and a projector cart configured to house the projector, in which the projector includes an enclosure, a light source housed in the enclosure, a light modulator housed in the enclosure and configured to modulate light emitted from the light source, and a projection lens unit configured to emit the light modulated by the light modulator to an outside of the enclosure, and in a posture of using the projector, the projector cart includes a housing which is configured to house the projector and is configured to emit the light emitted from the projection lens unit to an outside of the projector cart, a base placed below the housing, and wheels placed below the base, and the base includes a rotor on which the housing is rotatably mounted.

A projector cart to the present disclosure is a projector cart configured to house a projector including an enclosure, a light source housed in the enclosure, a light modulator housed in the enclosure and configured to modulate light emitted from the light source, and a projection lens unit configured to emit the light modulated by the light modulator to an outside of the enclosure, and including, in a use posture, a housing which is configured to house the projector and is configured to emit the light emitted from the projection lens unit to an outside of the projector cart, a base placed below the housing, and wheels placed below the base, in which the base includes a rotor on which the housing is rotatably mounted.

### BRIEF DESCRIPTION OF THE DRAWINGS

FIG. 1 is a left-front perspective view of a projection system according to Embodiment 1.

FIG. 2 is a right-rear perspective view of the projection system according to Embodiment 1.

FIG. 3 is an exploded perspective view of a projector cart according to Embodiment 1.

FIG. 4 is a front view of the projection system according to Embodiment 1.

FIG. 5 is an exploded perspective view of a projector cart according to Embodiment 2.

FIG. 6 is a cross-sectional view of a projection system according to Embodiment 3.

FIG. 7 is a cross-sectional view of the projection system according to Embodiment 3 with an angle changed.

### DESCRIPTION OF EMBODIMENTS

Hereinafter, some embodiments of the present disclosure will be described with reference to the drawings. Reference character FR illustrated in each of the drawings represent front (a front direction) of a projection system 1 in an installed state, reference character UP represents above the projection system 1, and reference character RH represents right hand of the projection system 1. Although not illustrated, a direction opposite to the reference character FR represents rear of the projection system 1, a direction opposite to the reference character UP represents below the projection system 1, and a direction opposite to the reference character RH represents left hand of the projection system 1. Note that in the description, the directions of front, rear, right, left, up, and down are the same as the directions with respect to the projection system 1 described above unless otherwise described.

### Embodiment 1

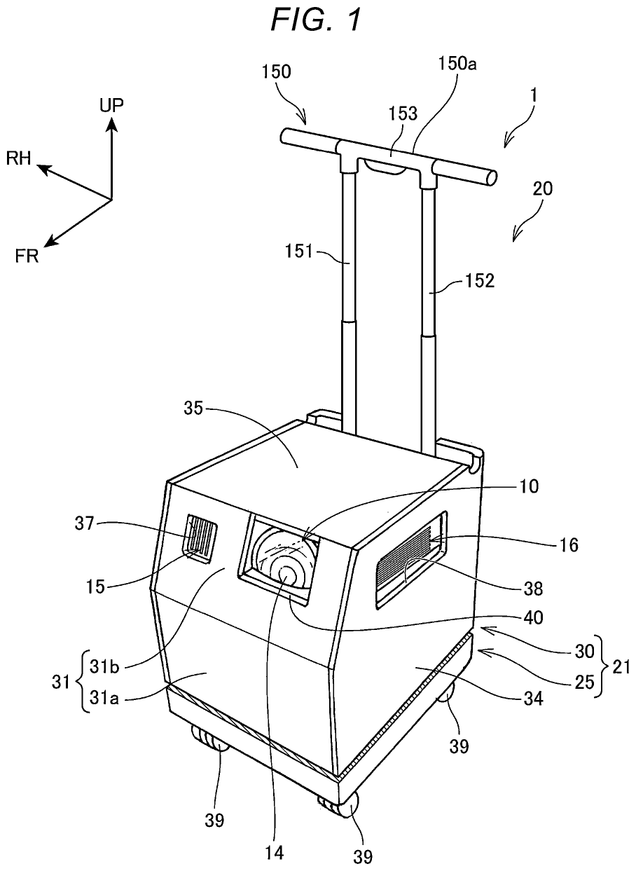

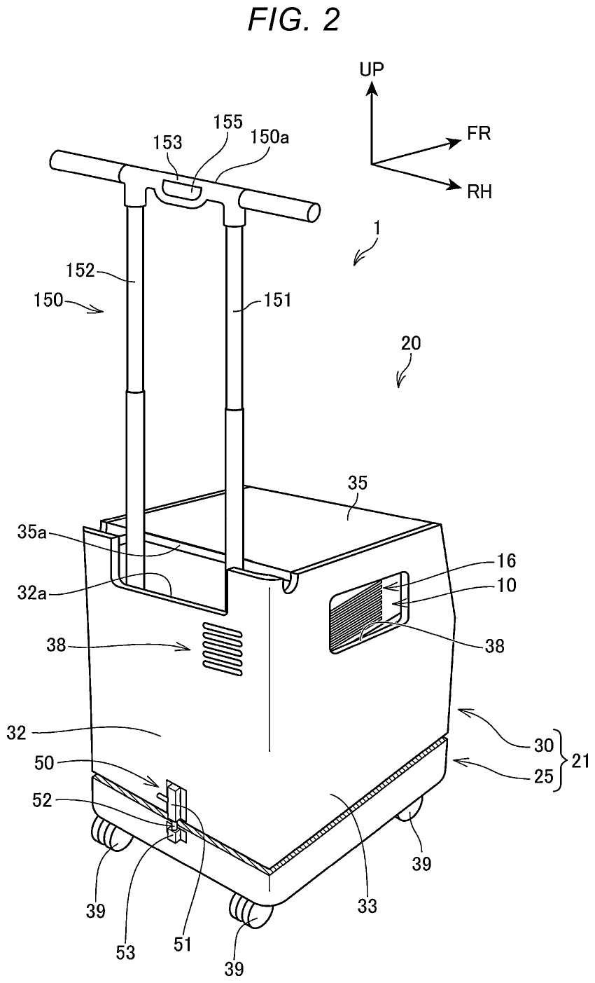

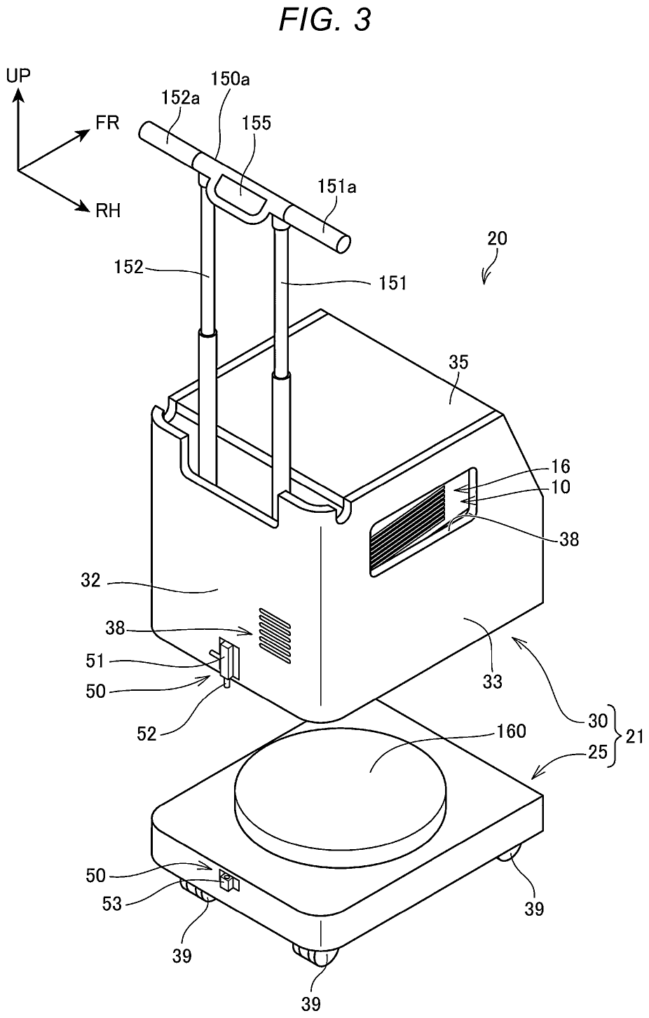

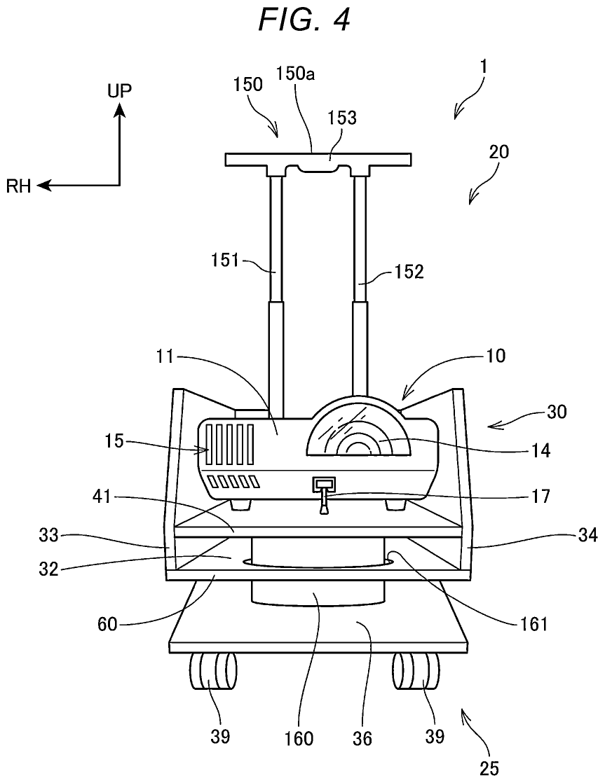

FIG. 1 is a left-front perspective view of the projection system 1. FIG. 2 is a right-rear perspective view of the projection system 1. FIG. 3 is an exploded perspective view of a projector cart 20. FIG. 4 is a front view of the projection system 1.

The projection system 1 includes a projector 10 that projects an image, and a projector cart 20 that houses the projector 10.

The projector 10 includes an enclosure 11, a light source, a light modulator, and a projection lens unit 14.

When the projector 10 is powered on, light is emitted from the light source. The light emitted from the light source is incident on the light modulator. The light modulator modulates the light emitted from the light source. The light modulated by the light modulator is emitted to the outside of the enclosure 11 by the projection lens unit 14, and an image can be projected onto a projection surface.

The enclosure 11 of the projector 10 is provided with an inlet 15 for air intake and a heat exhaust port 16 for heat rejection. Further, a leg 17 which makes it possible to adjust the projection surface in a vertical direction is provided in a lower portion of the enclosure 11 of the projector 10.

The projector cart 20 houses the projector 10, and it is possible to move the projector cart 20. Examples of the movement of the projector cart 20 include movement by human power and movement by a robot.

The projector cart 20 includes a gripper 150 and a cart body 21. The cart body 21 includes a base part (base) 25 forming a bottom of the cart body 21, and a housing 30 supported by the bottom and forming a side portion and an upper portion. The base part 25 and the housing 30 are provided with a lock mechanism (a fixation part) 50.

The cart body 21 includes an upper surface (a fifth surface) 35 forming a top surface, a right surface (a third surface) 33 and a left surface (a fourth surface) 34 forming the right and the left thereof, a front surface (a first surface) 31 and a rear surface (a second surface) 32 forming the front and the rear thereof, and a support plate 60 forming a lower surface.

Note that each of the surfaces of the housing 30 may be formed of a plurality of surfaces. In the present embodiment, the front surface 31 includes a vertical surface 31a with respect to a horizontal floor and an inclined surface 31b crossing the vertical surface 31a. The upper surface 35 is placed substantially in parallel to the horizontal floor. By providing the horizontal surface in this way, it is possible to provide a stand for an electronic apparatus and so on to be coupled to the projector 10 housed in the housing 30.

A hole (a recess) 161 is provided to the support plate 60.

In the present embodiment, the housing 30 is provided with a divider 41 to divide the housing 30 into an upper space and a lower space. In the present embodiment, the projector 10 is housed above the divider 41, that is, in an upper space.

An intake hole 37 is provided to the front surface of the housing 30. Heat exhaust holes 38 are provided to the right surface 33 and the rear surface 32 of the housing 30. The intake hole 37 and the heat exhaust holes 38 are placed at positions that do not interfere with the intake and the heat rejection of the projector 10 placed inside the projector cart 20. Further, the intake hole 37 and the heat exhaust holes 38 may be formed of a plurality of slit holes. This makes it possible to prevent the temperature in the housing 30 from rising due to the heat exhaust air from the projector 10 even when the projector 10 is placed in the housing 30. That is, since the projector 10 is capable of discharging the heat exhaust air to the outside of the housing 30 of the projector cart 20, it is possible to prevent the heat exhaust air of the projector 10 from being retained in the housing 30, and it is possible to perform an intake operation and a heat exhaust operation without raising the temperature in the housing 30.

A window 40 for emitting the projection light from the projector 10 to the outside of the housing 30 is provided to at least one of the upper surface 35 and the front surface 31 of the housing 30. The window 40 is placed so as not to block the projection light from the projector 10. The window 40 may be formed by removing the upper surface 35 and the front surface 31. That is, the upper surface 35 and the front surface 31 of the housing 30 may be formed in a removable manner, and it is possible to use the projection system 1 in the state in which the upper surface 35 and the front surface 31 are removed.

The housing 30 is provided with the gripper 150 which functions as a handle when moving the projector cart 20. The gripper 150 is placed at a rear end of the housing 30. In the present embodiment, the gripper 150 includes a first support rod 151 and a second support rod 152 which extend in the vertical direction, and a coupling 153 which couples upper ends of the first support rod 151 and the second support rod 152 to each other. That is, the gripper 150 is formed to have an inverted U-shape in a front view. The first support rod 151 and the second support rod 152 have a first protrusion 151a and a second protrusion 152a that extend outward in a cart width direction from upper ends, respectively. The cart width direction means a direction along the reference character RH.

The coupling 153 of the gripper 150 is provided with an operation panel (a first operator) 155. The operation panel 155 is a touch display, and can perform an operation such as a power supply operation or a keystone correction of the projector 10 by the user touching an icon displayed on the touch display.

The gripper 150 is displaceable, and is formed so as to be retracted inside the housing 30 through the upper surface 35. Examples of the displacement configuration for retracting the gripper 150 in the housing 30 include a stretchable structure and a folded structure. Further, the gripper 150 can be freely changed in length by being exposed from the housing 30. That is, in the present disclosure, a retracted state includes not only a state in which a whole of the gripper 150 is retracted inside the housing 30, but also a state in which a part of the gripper 150 is retracted inside the housing 30 and a part thereof is exposed outside the housing 30.

The gripper 150 is formed such that a length from the upper surface 35 of the housing 30 to the operation panel 155 is longer than a length from the lower surface 36 to the upper surface 35 when the gripper 150 extends to the maximum. By providing the operation panel 155 to the gripper 150 in this way, it is not necessary to take out the projector 10 from the housing 30 in order to change the setting of the projector 10, and the projector cart 20 can be moved in a standing posture.

The gripper 150 can be contracted to a state in which the uppermost end 150a of the gripper 150 is located at a position equivalent to or lower than the upper surface 35 of the housing 30.

A cutout 35a for retracting the coupling 153 is placed at the rear end of the upper surface 35 of the housing 30. Further, the cutout 32a is also placed at the upper end of the rear surface 32 so that a part of the gripper 150 retracted therein is exposed to an outer end of the housing 30. In a state in which the gripper 150 is retracted in the housing 30 due to the cutouts 32a, 35a, a gap can be formed around the coupling 153 of the gripper 150, and the operator can grasp the gripper 150 to take it out. Further, when retracting the gripper 150, the operation panel 155 is exposed to the outer surface. That is, the operation panel 155 is located outside the housing 30, and it is possible for the user to operate the projector 10 with the operation panel 155 even when the gripper 150 is retracted.

The housing 30 is provided with a cable (not shown) for supplying power to the projector 10 and a wiring hole (not shown) for wiring the cable.

A part of each of the first support rod 151, the second support rod 152, and the coupling 153 has a hollow structure at least a part of which is hollow. A circuit to be controlled by an operation on the operation panel 155 is placed in the internal hollow. The circuit extends to the housing 30 and is coupled to the projector 10.

The base part 25 has a lower surface (a sixth surface) 36 forming a bottom surface of the cart body 21.

Wheels 39 are placed at one side surface of the lower surface 36. The wheels 39 are respectively placed at four corners of the lower surface 36. The wheels 39 are provided with stoppers (not shown), and the stoppers are capable of regulating rotations of the wheels. A rotor (a protrusion) 160 is placed at an upper portion of the base part 25, that is, at the other side surface of the lower surface 36 opposed to the one side surface thereof. The rotor 160 has a cylindrical shape in which an outer circumference has a curvature in a top view. The rotor 160 can rotate in the horizontal direction while fixing the base part.

The rotor 160 is inserted through the hole 161 provided to the support plate 60 of the housing 30 to support the divider 41.

The projector cart 20 can rotate the housing 30 by the rotor 160 provided to the base part 25 while fixing the base part 25. In the present embodiment, the support plate 60 provided to the housing 30 forms the hole 161 substantially the same in shape as the rotor 160. Accordingly, the housing 30 is prevented from dropping from the base part 25 to be deviated in the front-rear or left-right direction from the projector cart 20.

The projector cart 20 is provided with a lock mechanism 50 for stopping the rotation in the horizontal direction. Accordingly, the operator can perform a fixation and a variation between the base part 25 and the housing 30 at will.

As the lock mechanism 50, for example, a slide type lock mechanism or a clip type lock mechanism can be applied.

In the present embodiment, the lock mechanism 50 is the slide type lock mechanism. The lock mechanism is placed in a rear portion of the projection system 1. The housing 30 is provided with a holder 51 and a round bar 52 which is supported by the holder 51 so as to be able to move vertically. The base part 25 is provided with a receiver 53. When the round bar 52 is moved downward, the receiver 53 and the round bar 52 mesh with each other. As a result, the housing 30 and the base part 25 are fixed to each other, and movement of the rotor 160 is prevented. That is, the rotor 160 can be prevented from moving when the projection system 1 moves.

Further, when the round bar 52 is moved upward, the round bar 52 is detached from the receiver 53, and the fixation between the housing 30 and the base part 25 is released. Accordingly, the rotor 160 becomes movable, and the housing 30 can be moved horizontally in a state where the base part 25 is fixed. That is, only the housing 30 can be moved horizontally, and the projection surface of the projector 10 can be easily adjusted.

As described above, the operator can perform the fixation and the variation between the base part 25 and the housing 30 at will as necessary by using the lock mechanism 50.

### Advantages of Embodiment 1

As described hereinabove, the projector 10 and the projector cart 20 for housing the projector 10 are provided, the projector 10 includes the enclosure 11, the light source housed in the enclosure 11, the light modulator configured to modulate the light emitted from the light source, and the projection lens unit 14 configured to emit the light modulated by the light modulator to the outside of the enclosure 11, and in a posture of using the projector 10, the projector cart 20 includes the housing 30 which is capable of housing the projector 10, and is capable of emitting the light emitted from the projection lens unit 14 to the outside of the projector cart 20, the base part 25 placed below the housing 30, and the wheels 39 placed below the base part 25, and the base part 25 includes the rotor 160 on which the housing 30 is rotatably mounted.

Accordingly, by providing the rotor 160 to the base part 25 located below the housing, the housing 30 can be rotated without moving the wheels 39. Therefore, it is possible to easily perform the fine adjustment of the projection position of the projector 10.

In the posture of using the projector 10, when defining a vertical direction as a Z axis, a direction orthogonal to the Z axis as a Y axis, and a direction orthogonal to the Z axis and the Y axis as an X axis, the housing 30 is placed so as to be rotatable with respect to the base part 25 along an X-Y plane parallel to the X axis and the Y axis with the Z-axis direction as an axis.

Accordingly, it is possible to easily perform the fine adjustment of the projection position of the projector 10 in the horizontal direction by installing the housing 30 so as to be rotatable along the X-Y plane.

The rotor 160 is a protrusion 160 provided to a surface of the base part 25 opposed to the housing 30, and in the posture of using the projector 10, the outer circumference of the rotor 160 has a curvature in a plan view of the projection system 1 in a vertically downward direction.

Accordingly, it is possible to easily realize a structure in which the housing 30 rotates along the horizontal direction with respect to the base part 25.

In the posture of using the projector 10, the projector cart 20 includes a gripper 150 which is attached to the housing 30 and extends to a position higher than the housing 30.

Accordingly, a relative position of the housing 30 to the base part 25 can easily be adjusted by grasping and operating the gripper 150.

The projector cart 20 includes the lock mechanism 50 capable of fixing the position of the housing 30 with respect to the base part 25.

Accordingly, it is possible to maintain a desired posture after rotating the housing 30 so as to have a desired posture with respect to the base part 25.

### Embodiment 2

Embodiment 2 to which the present disclosure is applied will be described. In Embodiment 2, constituents substantially the same as those of Embodiment 1 described above will be denoted by the same reference numerals to omit the descriptions thereof.

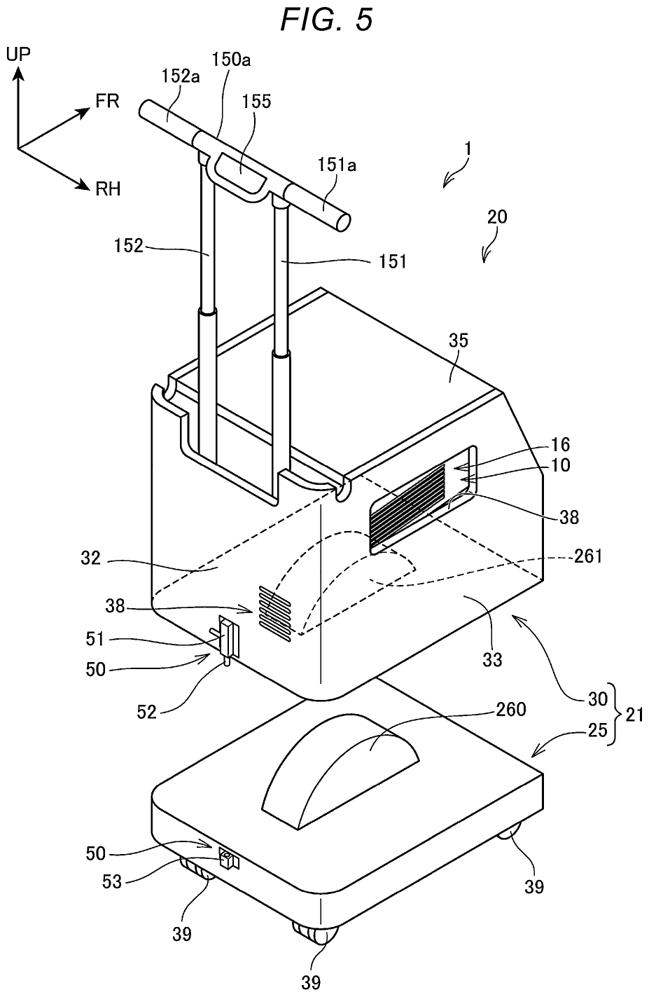

FIG. 5 is an exploded perspective view of the projector cart 20.

In Embodiment 2, an aspect corresponding to the rotor 160 is different from Embodiment 1. In Embodiment 1, the rotor 160 having a cylindrical shape is provided.

In contrast, in Embodiment 2, the base part 25 is provided with a protrusion 260 shaped like an arch an outer circumference of which has a curvature in a side view. Further, correspondingly, a recess 261 having a shape corresponding to the shape of the protrusion 260 is provided to the housing 30.

The housing is supported by the base part by engaging the recess with the protrusion of the base part.

In this way, since the protrusion of the base part is engaged with the recess of the housing, by moving the recess of the housing along a curved surface of the protrusion, an angle adjustment of the housing 30 in an up-and-down direction can be performed.

### Advantages of Embodiment 2

In the posture of using the projector 10, when defining a vertical direction as a Z axis, a direction orthogonal to the Z axis as a Y axis, a direction orthogonal to the Z axis and the Y axis as an X axis, and the X axis as a direction in which the projection lens unit 14 emits the light, the housing 30 is placed so as to be rotatable with respect to the base part 25 along an X-Z plane parallel to the X axis and the Z axis with the Y-axis direction as an axis.

Accordingly, it is possible to easily perform the fine adjustment of the projection position of the projector 10 in the vertical direction by installing the housing 30 so as to be rotatable along the X-Z plane.

A rotor 260 is the protrusion 260 or the recess 261 provided to a surface of the base part 25 opposed to the housing 30, and in the posture of using the projector 10, the outer circumference of the protrusion 260 or the recess 261 has a curvature in a plan view of the projection system 1 in the Y-axis direction.

Accordingly, it is possible to easily realize a structure in which the housing 30 rotates along the vertical direction with respect to the base part 25.

### Embodiment 3

Embodiment 3 to which the present disclosure is applied will be described. In Embodiment 3, constituents substantially the same as those of Embodiment 1 described above will be denoted by the same reference numerals to omit the descriptions thereof.

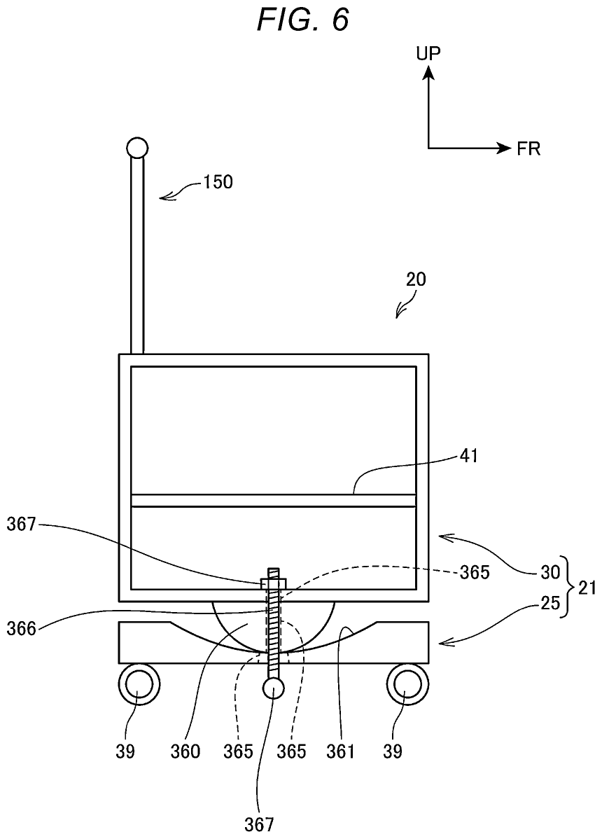

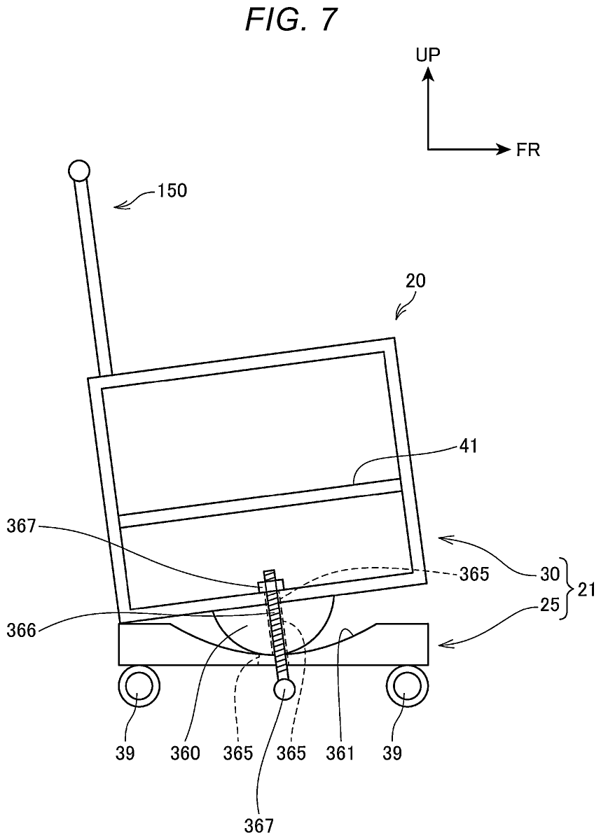

FIG. 6 is a cross-sectional view of the projection system 1. FIG. 7 is a cross-sectional view of the projection system 1 with an angle changed.

In Embodiment 3, a rotational structure corresponding to the rotor 160 is different from that in Embodiment 1.

In Embodiment 1, the rotor 160 is provided to the base part 25, and the hole 161 is provided to the housing 30 to thereby support the housing 30 by the rotor 160.

In contrast, in Embodiment 3, a protrusion 360 having a hemispherical shape is provided to the lower surface of the support plate 60 of the housing 30. The base part 25 is provided with a recess 361 corresponding to the protrusion 360. A through hole 365 is formed so as to penetrate the support plate 60, the protrusion 360, the recess 361, and the base part 25 in a vertical direction. A bolt 366 is inserted into the through hole 365 from the base part 25 side, and the bolt 366 is fixed with a nut 367 from above the support plate 60 of the housing 30.

In this way, the base part 25 and the housing 30 are integrally fixed to each other, and the housing 30 can be tilted in the horizontal direction and the vertical direction to adjust the position of the projection image of the projector.

### Advantages of Embodiment 3

In the posture of using the projector 10, when defining a vertical direction as a Z axis, a direction orthogonal to the Z axis as a Y axis, a direction orthogonal to the Z axis and the Y axis as an X axis, and the X axis as a direction in which the projection lens unit 14 emits the light, the housing 30 is placed so as to be rotatable with respect to the base part 25 along the X-Y plane parallel to the X axis and the Y axis with the Z-axis direction as an axis, and the housing 30 is placed so as to be rotatable with respect to the base part 25 along the X-Z plane parallel to the X axis and the Z axis with the Y-axis direction as an axis.

Accordingly, it is possible to easily perform the fine adjustment of the projection position of the projector 10 in the vertical direction and the horizontal direction by installing the housing 30 so as to be rotatable along the X-Y plane, and rotatable along the X-Z plane.

The rotor 160 corresponds to the protrusion 360 or the recess 361 provided to a surface of the base part 25 opposed to the housing 30, and in the posture of using the projector 10, the outer circumference of the protrusion 360 or the recess 361 has a first curvature in the plan view of the projection system 1 in the Y-axis direction, and in the posture of using the projector 10, the outer circumference of the protrusion 360 or the recess 361 has a second curvature in the plan view of the projection system 1 in the Z-axis direction.

Accordingly, it is possible to easily realize the structure in which the housing 30 is rotatable with respect to the base part 25 along the vertical direction, and is rotatable with respect to the base part 25 along the horizontal direction.

### Other Embodiments

The embodiments described above are merely examples of the present disclosure, and can be modified and applied as appropriate within the scope and spirit of the present disclosure.

In Embodiment 1, the lock mechanism 50 is placed in the rear portion of the cart body 21. However, the installation position of the lock mechanism 50 can be changed. Further, a plurality of lock mechanisms 50 may be provided, or only a plurality of receivers 53 may be provided. Further, the receiver 53 may be formed by providing a hole to the base part 25.

### SUMMARY OF PRESENT DISCLOSURE

Hereinafter, the present disclosure will be summarized as supplementary notes.

(Supplementary Note 1) A projection system including a projector, and a projector cart configured to house the projector, in which the projector includes an enclosure, a light source housed in the enclosure, a light modulator housed in the enclosure and configured to modulate light emitted from the light source, and a projection lens unit configured to emit the light modulated by the light modulator to an outside of the enclosure, and in a posture of using the projector, the projector cart includes a housing which is configured to house the projector and is configured to emit the light emitted from the projection lens unit to an outside of the projector cart, a base placed below the housing, and wheels placed below the base, and the base includes a rotor on which the housing is rotatably mounted.

Accordingly, by providing the rotor to the base located below the housing, the housing can be rotated without moving the wheels. Therefore, it is possible to easily perform the fine adjustment of the projection position of the projector.

(Supplementary Note 2) The projection system described in Supplementary Note 1, in which, in the posture of using the projector, when defining a vertical direction as a Z axis, a direction orthogonal to the Z axis as a Y axis, and a direction orthogonal to the Z axis and the Y axis as an X axis, the housing is placed so as to be rotatable with respect to the base along an X-Y plane parallel to the X axis and the Y axis with the Z-axis direction as an axis.

Accordingly, it is possible to easily perform the fine adjustment of the projection position of the projector in the horizontal direction by installing the housing so as to be rotatable along the X-Y plane.

(Supplementary Note 3) The projection system described in Supplementary Note 2, in which the rotor is a protrusion or a recess provided to a surface of the base opposed to the housing, and in the posture of using the projector, an outer circumference of the protrusion or the recess has a curvature in a plan view of the projection system in a vertically downward direction.

Accordingly, it is possible to easily realize a structure in which the housing rotates along the horizontal direction with respect to the base.

(Supplementary Note 4) The projection system described in Supplementary Note 1, in which, in the posture of using the projector, when defining a vertical direction as a Z axis, a direction orthogonal to the Z axis as a Y axis, a direction orthogonal to the Z axis and the Y axis as an X axis, and the X axis as a direction in which the projection lens unit emits the light, the housing is placed so as to be rotatable with respect to the base along an X-Z plane parallel to the X axis and the Z axis with the Y-axis direction as an axis.

Accordingly, it is possible to easily perform the fine adjustment of the projection position of the projector in the vertical direction by installing the housing so as to be rotatable along the X-Z plane.

(Supplementary Note 5) The projection system described in Supplementary Note 4, in which the rotor is a protrusion or a recess provided to a surface of the base opposed to the housing, and in the posture of using the projector, an outer circumference of the protrusion or the recess has a curvature in a plan view of the projection system in the Y-axis direction.

Accordingly, it is possible to easily realize a structure in which the housing rotates along the vertical direction with respect to the base.

(Supplementary Note 6) The projection system described in Supplementary Note 1, in which, in the posture of using the projector, when defining a vertical direction as a Z axis, a direction orthogonal to the Z axis as a Y axis, a direction orthogonal to the Z axis and the Y axis as an X axis, and the X axis as a direction in which the projection lens unit emits the light, the housing is placed so as to be rotatable with respect to the base along an X-Y plane parallel to the X axis and the Y axis with the Z-axis direction as an axis, and the housing is placed so as to be rotatable with respect to the base along an X-Z plane parallel to the X axis and the Z axis with the Y-axis direction as an axis.

Accordingly, it is possible to easily perform the fine adjustment of the projection position of the projector in the vertical direction and the horizontal direction by installing the housing so as to be rotatable along the X-Y plane, and rotatable along the X-Z plane.

(Supplementary Note 7) The projection system described in Supplementary Note 6, in which the rotor is a protrusion or a recess provided to a surface of the base opposed to the housing, and in the posture of using the projector, an outer circumference of the protrusion or the recess has a first curvature in a plan view of the projection system in the Y-axis direction, and in the posture of using the projector, an outer circumference of the protrusion or the recess has a second curvature in a plan view of the projection system in the Z-axis direction.

Accordingly, it is possible to easily realize the structure in which the housing is rotatable with respect to the base along the vertical direction, and is rotatable with respect to the base along the horizontal direction.

(Supplementary Note 8) The projection system described in any one of Supplementary Notes 1 to 7, in which, in a posture of using the projector, the projector cart includes a gripper attached to the housing and extending to a position higher than the housing.

Accordingly, a relative position of the housing to the base can easily be adjusted by grasping and operating the gripper.

(Supplementary Note 9) The projection system described in any one of Supplementary Notes 1 to 8, in which the projector cart includes a fixation part configured to fix a position of the housing with respect to the base.

Accordingly, it is possible to maintain a desired posture after rotating the housing so as to have a desired posture with respect to the base.

(Supplementary Note 10) A projector cart configured to house a projector including an enclosure, a light source housed in the enclosure, a light modulator housed in the enclosure and configured to modulate light emitted from the light source, and a projection lens unit configured to emit the light modulated by the light modulator to an outside of the enclosure, the projector cart including, in a use posture, a housing which is configured to house the projector and is configured to emit the light emitted from the projection lens unit to an outside of the projector cart, a base placed below the housing, and wheels placed below the base, in which the base includes a rotor on which the housing is rotatably mounted.

Accordingly, by providing the rotor to the base located below the housing, the housing can be rotated without moving the wheels. Therefore, it is possible to easily perform the fine adjustment of the projection position of the projector.

(Supplementary Note 11) The projector cart described in Supplementary Note 10, in which, in the use posture, when defining a vertical direction as a Z axis, a direction orthogonal to the Z axis as a Y axis, and a direction orthogonal to the Z axis and the Y axis as an X axis, the housing is placed so as to be rotatable with respect to the base along an X-Y plane parallel to the X axis and the Y axis with the Z-axis direction as an axis.

Accordingly, it is possible to easily perform the fine adjustment of the projection position of the projector in the horizontal direction by installing the housing so as to be rotatable along the X-Y plane.

(Supplementary Note 12) The projection system described in Supplementary Note 11, in which the rotor is a protrusion or a recess provided to a surface of the base opposed to the housing, and in the posture of using the projector cart, an outer circumference of the protrusion or the recess has a curvature in a plan view of the projector cart in a vertically downward direction.

Accordingly, it is possible to easily realize a structure in which the housing rotates along the horizontal direction with respect to the base.

(Note 13) The projector cart according to Supplementary Note 10, in which, in the posture of using the projector cart, when defining a vertical direction as a Z axis, a direction orthogonal to the Z axis as a Y axis, a direction orthogonal to the Z axis and the Y axis as an X axis, and the X axis as a direction in which the projection lens unit emits the light, the housing is placed so as to be rotatable with respect to the base along an X-Z plane parallel to the X axis and the Z axis with the Y-axis direction as an axis.

Accordingly, it is possible to easily perform the fine adjustment of the projection position of the projector in the vertical direction by installing the housing so as to be rotatable along the X-Z plane.

(Supplementary Note 14) The projector cart according to Supplementary Note 13, in which the rotor is a protrusion or a recess provided to a surface of the base opposed to the housing, and in the posture of using the projector cart, an outer circumference of the protrusion or the recess has a curvature in a plan view of the projector cart in the Y-axis direction.

Accordingly, it is possible to easily realize a structure in which the housing rotates along the vertical direction with respect to the base.

(Supplementary Note 15) The projector cart described in Supplementary Note 10, in which, in the posture of using the projector cart, when defining a vertical direction as a Z axis, a direction orthogonal to the Z axis as a Y axis, a direction orthogonal to the Z axis and the Y axis as an X axis, and the X axis as a direction in which the projection lens unit emits the light, the housing is placed so as to be rotatable with respect to the base along an X-Y plane parallel to the X axis and the Y axis with the Z-axis direction as an axis, and the housing is placed so as to be rotatable with respect to the base along an X-Z plane parallel to the X axis and the Z axis with the Y-axis direction as an axis.

Accordingly, it is possible to easily perform the fine adjustment of the projection position of the projector in the vertical direction and the horizontal direction by installing the housing so as to be rotatable along the X-Y plane, and rotatable along the X-Z plane.

(Supplementary Note 16) The projector cart according to Supplementary Note 15, in which the rotor is a protrusion or a recess provided to a surface of the base opposed to the housing, and in the use posture, an outer circumference of the protrusion or the recess has a first curvature in a plan view of the projector cart in the Y-axis direction, and in the use posture, an outer circumference of the protrusion or the recess has a second curvature in a plan view of the projector cart in the Z-axis direction.

Accordingly, it is possible to easily realize the structure in which the housing is rotatable with respect to the base along the vertical direction, and is rotatable with respect to the base along the horizontal direction.

(Supplementary Note 17) The projector cart described in any one of Supplementary Notes 10 to 16, further including, in the use posture, a gripper attached to the housing and extending to a position higher than the housing.

Accordingly, a relative position of the housing to the base can easily be adjusted by grasping and operating the gripper.

(Supplementary Note 18) The projector cart described in any one of Supplementary Notes 10 to 17, further including a fixation part configured to fix a position of the housing with respect to the base.

Accordingly, it is possible to maintain a desired posture after rotating the housing so as to have a desired posture with respect to the base.

What is claimed is:

1. A projection system comprising:
a projector; and
a projector cart configured to house the projector, wherein
the projector includes an enclosure, a light source housed in the enclosure, a light modulator housed in the enclosure and configured to modulate light emitted from the light source, and a projection lens unit configured to emit the light modulated by the light modulator to an outside of the enclosure, and
in a posture of using the projector,
the projector cart includes a housing which is configured to house the projector and is configured to emit the light emitted from the projection lens unit to an outside of the projector cart, a base placed below the housing, and wheels placed below the base, and
the base includes a rotor on which the housing is rotatably mounted.

2. The projection system according to claim 1, wherein,
in the posture of using the projector,
when defining a vertical direction as a Z axis, a direction orthogonal to the Z axis as a Y axis, and a direction orthogonal to the Z axis and the Y axis as an X axis,
the housing is placed so as to be rotatable with respect to the base along an X-Y plane parallel to the X axis and the Y axis with the Z-axis direction as an axis.

3. The projection system according to claim 2, wherein
the rotor is a protrusion or a recess provided to a surface of the base opposed to the housing, and
in the posture of using the projector, an outer circumference of the protrusion or the recess has a curvature in a plan view of the projection system in a vertically downward direction.

4. The projection system according to claim 1, wherein,
in the posture of using the projector,
when defining a vertical direction as a Z axis, a direction orthogonal to the Z axis as a Y axis, a direction orthogonal to the Z axis and the Y axis as an X axis, and the X axis as a direction in which the projection lens unit emits the light,
the housing is placed so as to be rotatable with respect to the base along an X-Z plane parallel to the X axis and the Z axis with the Y-axis direction as an axis.

5. The projection system according to claim 4, wherein
the rotor is a protrusion or a recess provided to a surface of the base opposed to the housing, and
in the posture of using the projector, an outer circumference of the protrusion or the recess has a curvature in a plan view of the projection system in the Y-axis direction.

6. The projection system according to claim 1, wherein,
in the posture of using the projector,
when defining a vertical direction as a Z axis, a direction orthogonal to the Z axis as a Y axis, a direction orthogonal to the Z axis and the Y axis as an X axis, and the X axis as a direction in which the projection lens unit emits the light,
the housing is placed so as to be rotatable with respect to the base along an X-Y plane parallel to the X axis and the Y axis with the Z-axis direction as an axis, and
the housing is placed so as to be rotatable with respect to the base along an X-Z plane parallel to the X axis and the Z axis with the Y-axis direction as an axis.

7. The projection system according to claim 6, wherein
the rotor is a protrusion or a recess provided to a surface of the base opposed to the housing, and
in the posture of using the projector, an outer circumference of the protrusion or the recess has a first curvature in a plan view of the projection system in the Y-axis direction, and
in the posture of using the projector, an outer circumference of the protrusion or the recess has a second curvature in a plan view of the projection system in the Z-axis direction.

8. The projection system according to claim 1, wherein,
in a posture of using the projector,
the projector cart includes a gripper attached to the housing and extending to a position higher than the housing.

9. The projection system according to claim 1, wherein
the projector cart includes a fixation part configured to fix a position of the housing with respect to the base.

10. A projector cart configured to house a projector including an enclosure, a light source housed in the enclosure, a light modulator housed in the enclosure and configured to modulate light emitted from the light source, and a projection lens unit configured to emit the light modulated by the light modulator to an outside of the enclosure, the projector cart comprising:
in a posture of using the projector,
a housing which is configured to house the projector and is configured to emit the light emitted from the projection lens unit to an outside of the projector cart;
a base placed below the housing;
and wheels placed below the base, wherein
the base includes a rotor on which the housing is rotatably mounted.

11. The projector cart according to claim 10, wherein,
in the use posture, when defining a vertical direction as a Z axis, a direction orthogonal to the Z axis as a Y axis, and a direction orthogonal to the Z axis and the Y axis as an X axis,
the housing is placed so as to be rotatable with respect to the base along an X-Y plane parallel to the X axis and the Y axis with the Z-axis direction as an axis.

12. The projector cart according to claim 11, wherein
the rotor is a protrusion or a recess provided to a surface of the base opposed to the housing, and
in the use posture, an outer circumference of the protrusion or the recess has a curvature in a plan view of the projector cart in a vertically downward direction.

13. The projector cart according to claim 10, wherein,
in the use posture, when defining a vertical direction as a Z axis, a direction orthogonal to the Z axis as a Y axis, a direction orthogonal to the Z axis and the Y axis as an X axis, and the X axis as a direction in which the projection lens unit emits the light,
the housing is placed so as to be rotatable with respect to the base along an X-Z plane parallel to the X axis and the Z axis with the Y-axis direction as an axis.

14. The projector cart according to claim 13, wherein
the rotor is a protrusion or a recess provided to a surface of the base opposed to the housing, and
in the use posture, an outer circumference of the protrusion or the recess has a curvature in a plan view of the projector cart in the Y-axis direction.

15. The projector cart according to claim 10, wherein,
in the use posture, when defining a vertical direction as a Z axis, a direction orthogonal to the Z axis as a Y axis, a direction orthogonal to the Z axis and the Y axis as an X axis, and the X axis as a direction in which the projection lens unit emits the light,
the housing is placed so as to be rotatable with respect to the base along an X-Y plane parallel to the X axis and the Y axis with the Z-axis direction as an axis, and
the housing is placed so as to be rotatable with respect to the base along an X-Z plane parallel to the X axis and the Z axis with the Y-axis direction as an axis.

16. The projector cart according to claim 15, wherein
the rotor is a protrusion or a recess provided to a surface of the base opposed to the housing, and
in the use posture, an outer circumference of the protrusion or the recess has a first curvature in a plan view of the projector cart in the Y-axis direction, and
in the use posture, an outer circumference of the protrusion or the recess has a second curvature in a plan view of the projector cart in the Z-axis direction.

17. The projector cart according to claim 10, further comprising:
in the use posture, a gripper attached to the housing and extending to a position higher than the housing.

18. The projector cart according to claim 10, further comprising:
a fixation part configured to fix a position of the housing with respect to the base.
